(19) United States
(12) Patent Application Publication
(10) Pub. No.: US 2015/0299413 A1
(43) Pub. Date: Oct. 22, 2015

(54) THERMOFORMABLE MELAMINE RESIN FOAM WITH PARTICULATE FILLER MATERIAL

(71) Applicant: BASF SE, Ludwigshafen (DE)

(72) Inventors: Tobias Heinz STEINKE, Speyer (DE); Hoest BAUMGARTL, Ludwigshafen (DE); Werner LENZ, Ludwigshafen (DE); Klaus HAHN, Kirchheim (DE)

(21) Appl. No.: 14/646,792

(22) PCT Filed: Nov. 25, 2013
(86) PCT No.: PCT/EP2013/074547

§ 371 Date: May 22, 2015

(30) Foreign Application Priority Data
Nov. 26, 2012 (EP) 12194173.6

(51) Int. Cl. C08J 9/14; C08J 9/00

(52) U.S. Cl. CPC C08J 9/141; C08J 9/0023; C08J 9/0033; C08J 2203/14; C08J 2379/04

(57) ABSTRACT

The present invention relates to a thermoformable melamine-formaldehyde foam comprising from 0.1 to 50 wt % of at least one particulate filling material, wherein the wt % are based on the total weight of filling material plus melamine-formaldehyde precondensate used for foam production, wherein the at least one particulate filling material has a melting point no higher than 220° C. and an average particle diameter in the range from 5 μm to 750 μm, to a process for producing the thermoformable melamine-formaldehyde foam and also to the use of the melamine-formaldehyde foam for acoustical or thermal insulation in building construction, in automobile, ship and track vehicle construction, the construction of spacecraft, in the upholstery industry or for insulating pipework lines.

The present invention concerns thermocompressible melamine resin foams, processes for their production and their use.

Open-cell resilient foams based on melamine-formaldehyde resins and also their methods of making using hot air, steam or microwave irradiation to heat, expand and crosslink a blowable solution or dispersion of a melamine-formaldehyde precondensate are known in that they are described in EP-A 17672 and EP-A 37470 for example.

While articles having simple shapes, examples being panels or strips, can be cut or sawn out of the foam, more involved methods of shaping are needed for articles having a more complicated, three-dimensional shape. Complicatedly shaped articles of this type are used, for example, in motor vehicles, for example to insulate the engine compartment, or machinery or as pipe insulation. FR-A 1 108336 discloses producing such articles by compressing a foam which is undergoing curing but is still formable and then curing the foam thus compressed. U.S. Pat. No. 3,504,064 and EP-A 464 490 describe processes wherein the foam is shaped before or after treatment with water in liquid or vaporous form. EP-A 111 860 describes compression-molding melamine resin foams at 60 to 300° C. and at least 1.2 bar abs.

The shaped melamine-formaldehyde resin articles obtained according to the aforementioned methods comprise residual quantities of unconverted formaldehyde, which are continuously emitted to the ambient air for a long time. These formaldehyde emissions increase with increasing temperature and humidity. They are undesirable in that they are disadvantageous when the shaped articles are used in closed spaces in particular.

WO 01/94436 teaches a process for producing melamine-formaldehyde foams having reduced formaldehyde evolution by using a melamine-formaldehyde precondensate having a molar ratio above 2:1 for formaldehyde:melamine. The blowable mixture to be foamed is expanded into, for example, cuboid strands or slabs by heating. Thereafter, the expanded slabs of foam are cured/conditioned at 120 to 300° C. for 1 to 180 min. The low-formaldehyde foams thus obtained lack thermoformability.

EP-A 1 505 105 describes a process for producing shaped articles from melamine-formaldehyde foams having low formaldehyde evolution wherein the as-produced foam is conditioned at temperatures between 100 and 160° C. before thermoforming. At the thermoforming stage, the foams can be covered or laminated on one or both of their sides with outer layers, for example paper, paperboard, glass veil, wood, gypsumboard panels, metal sheets or foils or polymeric films/sheets, which optionally may each also be in a foamed state. On compression molding in a contour mold, the mold geometry is perfectly reproduced with stable, uninterrupted, mechanically strong lips.

WO06/134083 describes a process for producing thermoformable melamine-formaldehyde foams having low formaldehyde evolution and also the production of shaped articles by thermoforming. Low formaldehyde emissions are achieved by using a melamine-formaldehyde precondensate having a molar ratio of less than 1:2 for melamine:formaldehyde and also by the use of formaldehyde scavengers.

WO 2012/113740 describes the foaming of particulate organic or inorganic filling materials with melamine-formaldehyde condensation products. This provides filled melamine resin foams that largely retain the good mechanical properties of the unfilled foams. This reference further notes that the foam slabs/sheets comprising particulate filling material can be thermocompressed in a further operation.

WO 2011/095409 describes, for example, melamine-formaldehyde foams containing microcapsules having an average particle diameter of 0.5-100 μm. The microcapsules are preferably incorporated in the foam structure at the nodal points or struts.

WO 2011/061178 describes melamine-formaldehyde foams containing expanded hollow microbeads having an average particle diameter of 70-250 μm. The hollow microbeads are preferably incorporated in the foam structure in the pores thereof. Incorporation in the pores is achieved by a multi-step method of production wherein the melamine-formaldehyde foam is produced in a first step and the hollow microbeads are introduced into the foam in a second, additional impregnating step.

The present invention has for its object to use a melamine-formaldehyde precondensate having a molar ratio greater than 2 for formaldehyde:melamine to provide a corresponding thermoformable melamine-formaldehyde foam which at the same as having good mechanical properties has minimal formaldehyde emissions of, for example, less than 0.1 ppm, preferably even before thermoforming into shaped articles. It is a further object of the present invention to provide a process for producing this thermoformable foam and/or for producing corresponding shaped articles.

We have found that these objects are achieved according to the present invention by a thermoformable melamine-formaldehyde foam comprising from 0.1 to 50 wt % of at least one particulate filling material, wherein the wt % are based on the total weight of filling material plus melamine-formaldehyde precondensate used for foam production, wherein the at least one particulate filling material has a melting point no higher than 220° C. and an average particle diameter in the range from 5 μm to 750 μm.

The thermoformable melamine-formaldehyde foams of the present invention comprise from 0.1 to 50 wt %, preferably from 1 to 40 wt %, more preferably from 5 to 35 wt % and most preferably from 10 to 30 wt % of one or more, i.e., from 1 to 10, preferably from 1 to 5, more preferably from 1 to 3, especially 1 or 2 and most preferably 1, particulate filling materials, wherein the wt % are all based on the total weight of particulate filling material plus melamine-formaldehyde precondensate used for foam production.

According to the present invention, the particulate filling materials have an average particle diameter in the range from 5 μm to 750 μm, preferably 50 to 600 μm, and more preferably 100 to 500 μm (d₅₀ value, number averaged, determined via optical or electron microscopy combined with image analysis). The particle size distribution of the particulate filling materials can be mono-, bi- or multimodal.

The present invention therefore provides the thermoformable melamine-formaldehyde foam of the present invention wherein the at least one particulate filling material has an average particle diameter in the range from 5 μm to 750 μm, preferably 50 to 600 μm, and more preferably 100 to 500 μm (d₅₀ value, number averaged, determined via optical or electron microscopy combined with image analysis).

The individual particles of the particulate filling materials can themselves be constructed of smaller agglomerated particles, often referred to as primary particles. For example, the particulate filling materials can be used in the form of agglomerate particles having the above-described particle diameters, in which case each agglomerate consists of smaller primary particles. Such particles in agglomerate form are known in principle to a person skilled in the art and are described in the literature. They are obtainable, for example, by adding agglomerization auxiliaries to the primary particles and subsequent mixing.

According to the present invention, the filling materials are present in particle form, preferably the ratio of the longest axis to the shortest axis of the particles is in the range from 4:1 to 1:1, and spherical filling materials are particularly preferred.

Useful particulate filling materials include in principle any chemistries, while preference is given to organic oligomers and polymers known to a person skilled in the art and described in the literature.

The present invention therefore preferably provides the thermoformable melamine-formaldehyde foam of the present invention wherein organic oligomers or polymers are used as at least one particulate filling material.

The organic oligomers or polymers which according to the present invention are preferably used as particulate filling materials have a molecular weight of, for example, 1000 to 1 000 000 g/mol, preferably from 1000 to 100 000 g/mol, more preferably from 2000 to 50 000 g/mol and especially from 2000 to 20 000 g/mol.

The particulate filling materials used according to the present invention have a melting point no higher than 220° C., preferably no higher than 200° C. and more preferably no higher than 180° C. The particulate filling materials used according to the present invention generally have a melting point no lower than 100° C.

In the thermoformable melamine-formaldehyde foam of the present invention, the at least one particulate filling material has an average particle diameter in the range from 5 μm to 750 μm, preferably 50 to 600 μm, and more preferably 100 to 500 μm (d₅₀ value, number averaged, determined via optical or electron microscopy combined with image analysis), and a melting point no higher than 220° C., preferably no higher than 200° C. and more preferably no higher than 180° C.

The melting point of the at least one particulate filling material, preferably the organic oligomers or polymers, is essential according to the present invention, in combination with the particle sizes which are preferred according to the present invention, in that it leads to the polymer particles melting during the thermoforming operation, so what the present invention accomplishes is the conversion of a nonthermoformable thermoset into a very readily thermoformable melamine-formaldehyde foam which, after thermoforming, displays a particularly advantageous combination of high lip strength, good mechanical properties and low formaldehyde evolution.

Examples of appropriately suitable organic oligomers and polymers having a melting point which is suitable for the purposes of the present invention, i.e., no higher than 220° C., are selected from the group consisting of polyethylene, for example LOPE wax, polypropylene, polystyrene, polyesters, polycarbonates, polyamides, thermoplastic elastomers, for example thermoplastic polyurethane, and mixtures thereof.

Ullmann's Encyclopedia of Industrial Chemistry (Wiley) includes the following chapters regarding the recited thermoplastic materials: a) Polyethylene, edition 6, vol. 28, 2003, pp. 393-427; b) Polypropylene, edition 6, vol. 28, 2003, pp. 428-461; c) Polyesters, edition 6, vol. 28, 2003, pp. 75-102; d) Polycarbonates, edition 6, vol. 28, 2003, pp. 55-63; e) Polyamides, edition 6, vol. 28, 2003, pp. 25-54; f) Polyurethanes: edition 6, vol. 28, 2003, pp. 667-722; g) Polystyrene and Styrene Copolymers, edition 6, vol. 28, 2003, pp. 455-488 and h) Thermoplastic Elastomers, edition 6, vol. 36, 2003, pp. 667-722.

Particular preference according to the present invention is given to particulate filling materials which, owing to their melting point being no higher than 220° C., melt in the thermoforming step to form a melt which has a low in-flow viscosity and permits uniform coating of the three-dimensional, open-cell structure of struts.

A particularly preferred example is low density polyethylene (LDPE) wax, available from BASF SE under the trade name LUWAX A, especially with an average particle diameter of 50 to 600 μm, for example 0.42 mm (each a d₅₀ value, number averaged, determined via optical or electron microscopy combined with image analysis).

The melamine-formaldehyde foams of the present invention generally comprise an open-cell scaffolding of foamed material, the scaffolding comprising a multiplicity of interconnected, three-dimensionally branched struts, and in each of which the particulate fillers are preferably embedded in the pore structure. The particle size preferably corresponds to the average pore diameter of the foam structure, this average pore diameter being preferably in the range from 10 μm to 1000 μm and more particularly in the range from 50 μm to 600 μm (d₅₀ value, number averaged, determined via optical or electron microscopy combined with image analysis). The particulate fillers can thus be ideally bound into the pore structure of the open-cell foam and immobilized from all sides of the pore scaffolding. Such a structure cannot be produced by subsequent impregnation of the foamed material with filling materials, since for this the particle size of the fillers always has to be chosen such that the particle size is smaller than the pore size of the foamed material in order that distribution in the entire foamed material may be ensured.

The present invention therefore preferably provides the thermoformable melamine-formaldehyde foam of the present invention wherein the at least one particulate filling material is embedded in the pore structure of the foam and the average particle diameter corresponds to the average pore diameter of the foam structure.

The melamine-formaldehyde precondensates used for producing the melamine-formaldehyde foams of the present invention generally have a molar ratio above 2, preferably in the range from 2.5:1 to 3.5:1, for formaldehyde to melamine.

These melamine-formaldehyde condensation products, in addition to melamine, may comprise from 0 to 50 wt %, preferably from 0 to 40 wt %, more preferably from 0 to 30 wt % and especially from 0 to 20 wt %, all based on the melamine-formaldehyde precondensate, of other thermoset-formers and, in addition to formaldehyde, from 0 to 50 wt %, preferably from 0 to 40 wt %, more preferably from 0 to 30 wt % and especially from 0 to 20 wt %, all based on the melamine-formaldehyde precondensate, of other aldehydes, in cocondensed form. Preference is given to unmodified melamine-formaldehyde precondensates.

Useful thermoset-formers include for example alkyl- and aryl-substituted melamine, urea, urethanes, carboxamides, dicyandiamide, guanidine, sulfurylamide, sulfonamides, aliphatic amines, glycols, phenol or their derivatives.

Useful aldehydes include for example acetaldehyde, trimethylolacetaldehyde, acrolein, benzaldehyde, furfural, glyoxal, glutaraldehyde, phthalaldehyde, terephthalaldehyde or mixtures thereof. Further details concerning melamine-formaldehyde condensation products are found in Houben-Weyl, Methoden der organischen Chemie, volume 14/2, 1963, pages 319 to 402.

The present invention further provides the melamine-formaldehyde foam of the present invention which has a formaldehyde evolution, as measured to DIN 55666, of 0.1 ppm or less.

The melamine-formaldehyde foams of the present invention are obtainable as follows:

The particulate filling materials can be added before and/or during the resin synthesis from melamine and formaldehyde, but preferably to the ready-made melamine-formaldehyde condensate before and/or during the foaming operation.

A melamine-formaldehyde precondensate and a solvent can preferably be foamed with an acid, a dispersant, a blowing agent and at least one appropriate particulate filling material at temperatures above the boiling temperature of the blowing agent, dried and conditioned at a temperature above 200° C. subsequently.

The present invention therefore further provides a process for producing a thermoformable melamine-formaldehyde foam according to the present invention, which comprises at least one melamine-formaldehyde precondensate being foamed in a solvent with an acid, a dispersant, a blowing agent and at least one particulate filling material at temperatures above the boiling temperature of the blowing agent, dried and conditioned at a temperature above 200° C. subsequently.

As melamine-formaldehyde precondensates there may be used specially prepared ones, see the following review references: a) W. Woebcken, Kunststoffhandbuch 10. Duroplaste, Munich, Vienna 1988, b) Encyclopedia of Polymer Science and Technology, 3rd edition, vol. 1, Amino Resins, pages 340 to 370, 2003 c) Ullmann's Encyclopedia of Industrial Chemistry, 6th edition, vol. 2, Amino Resins, pages 537 to 565. Weinheim 2003, or commercially available precondensates of the two components, melamine and formaldehyde. The melamine-formaldehyde precondensates generally have a molar ratio above 2, preferably in the range from 2.5:1 to 3.5:1, for formaldehyde to melamine.

A preferred version of the process for producing the thermoformable melamine-formaldehyde foam of the present invention comprises the stages of:
(1) producing a suspension comprising a melamine-formaldehyde precondensate of the foam to be produced, appropriate particulate fillers and optionally further added components,
(2) foaming the precondensate by heating the suspension from step (1) to a temperature above the boiling point of the blowing agent,
(3) drying and conditioning the foam obtained from step (2).

The present invention further also provides a process for producing shaped articles by thermoforming a thermoformable foam of the present invention.

A shaped article is preferably obtained from the thermoformable melamine-formaldehyde foam of the present invention by converting the foam obtained in step (3) of the abovementioned process in step (4):
(4) thermoforming the foam obtained from step (3).

The process which the present invention provides for producing a shaped article therefore preferably comprises steps (1), (2), (3) and (4).

The individual steps of the process according to the present invention and the various possible versions will now be more particularly described.

The melamine-formaldehyde precondensate may be prepared in step (1) in the presence of added alcohols, for example methanol, ethanol or butanol, in order that partially or fully etherified condensates may be obtained. Forming the ether groups is a way of influencing the solubility of the melamine-formaldehyde precondensate and the mechanical properties of the fully cured material.

Anionic, cationic and nonionic surfactants and also mixtures thereof can be used as dispersant/emulsifier.

Useful anionic surfactants are selected for example from the group consisting of diphenylene oxide sulfonate, alkane- and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acylisethionates, alkyl ether carboxylates, N-acylsarcosinates, alkyl- and alkylether phosphates and mixtures thereof.

Useful nonionic surfactants are selected for example from the group consisting of alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters, alkylpolyglycosides and mixtures thereof.

Useful cationic emulsifiers are selected for example from the group consisting of alkyltriammonium salts, alkylbenzyldimethylammonium salts, alkylpyridinium salts and mixtures thereof.

The dispersants/emulsifiers can be used in amounts of 0.2 to 5 wt %, based on the melamine-formaldehyde precondensate.

The dispersants/emulsifiers and/or protective colloids can in principle be added to the crude dispersion at any time.

Depending on the choice of melamine-formaldehyde precondensate, the mixture comprises a blowing agent. The amount of blowing agent in the mixture generally depends on the desired density for the foam.

“Physical” or “chemical” blowing agents are suitable, see Encyclopedia of Polymer Science and Technology, vol. I, 3rd edition, Additives, pages 203 to 218, 2003.

Useful “physical” blowing agents include for example hydrocarbons, such as pentane, hexane, halogenated, more particularly chlorinated and/or fluorinated hydrocarbons, for example methylene chloride, chloroform, trichloroethane, chlorofluorocarbons, hydrochlorofluorocarbons (HCFCs), alcohols, for example methanol, ethanol, n-propanol or isopropanol, ethers, ketones and esters, for example methyl formate, ethyl formate, methyl acetate or ethyl acetate, in liquid form or air, nitrogen or carbon dioxide as gases.

Useful “chemical” blowing agents include for example isocyanates mixed with water, releasing carbon dioxide as effective blowing agent. It is further possible to use carbonates and bicarbonates mixed with acids, in which case carbon dioxide is again produced. Azo compounds are also suitable, an example being azodicarbonamide.

According to the present invention, the mixture generally comprises at least one blowing agent in an amount of 0.5 to 60 wt %, preferably 1 to 40 wt % and more preferably 1.5 to 30 wt % based on the melamine-formaldehyde precondensate in each case.

It is preferable according to the present invention to add a physical blowing agent having a boiling point between 0 and 80° C.

By way of curatives, it is possible to use acids which catalyze the further condensation of the melamine resin. The amount of these curatives is generally in the range from 0.01 to 20 wt % and preferably in the range from 0.05 to 5 wt %, all based on the precondensate. Useful acids include organic and inorganic acids, for example selected from the group consisting of hydrochloric acid, sulfuric acid, phosphoric acid, nitric acid, formic acid, acetic acid, oxalic acid, toluenesulfonic acids, amidosulfonic acids, acid anhydrides and mixtures thereof.

In a further embodiment, in addition to the melamine-formaldehyde precondensate of the foam to be produced and the appropriate filling materials, the mixture also comprises an emulsifier and also optionally a curative and optionally a blowing agent.

In a further embodiment, the mixture is free of further added substances. However, for some purposes, it can be advantageous to add from 0.1 to 20 wt % and preferably from 0.1 to 10 wt %, based on the melamine-formaldehyde precondensate, of customary added substances other than the particulate filling materials, such as fibers, dyes, flame retardants, UV stabilizers, agents for reducing the toxicity of fire gases or for promoting carbonization, scents, optical brighteners or pigments. These added substances preferably form a homogeneous distribution in the foamed material.

The dyes used are preferably water-soluble dyes, for example metal-complexed dyes. These dyes can be mixed with the filling materials beforehand.

The next step (2) of the process according to the present invention comprises the precondensate being foamed up generally by heating the suspension of the melamine-formaldehyde precondensate and of the at least one particulate filling material from step (1) to obtain a foamed material containing the at least one particulate filling material. To this end, the suspension is generally heated to a temperature above the boiling point of the blowing agent used and foamed in a closed mold.

The introduction of energy may preferably be effected via electromagnetic radiation, for example via high-frequency irradiation at 5 to 400 kW, preferably 5 to 200 kW and more preferably 9 to 120 kW per kilogram of the mixture used, in a frequency range from 0.2 to 100 GHz and preferably from 0.5 to 10 GHz. Magnetrons are a useful source of dielectric radiation, and one magnetron can be used or two or more magnetrons at the same time.

Step (3) of the process according to the present invention comprises the foam obtained in step (2) being conditioned at a temperature above 200° C. The conditioning temperature is preferably in the range from 200 to 280° C., especially 220 to 260° C. A so-called postcure takes place during conditioning in that the foam undergoes further curing. Conditioning can also be used to remove residues of volatile ingredients, for example monomer residues, blowing agents and other auxiliaries, to a substantial extent.

The density of the thermoformable foam is generally in the range from 3 to 50 kg/m³, preferably in the range from 5 to 40 kg/m³, more preferably in the range from 8 to 30 kg/m³ and most preferably in the range from 10 to 25 kg/m³.

In step (4) of the process according to the present invention, the conditioned foam obtained in step (3) is thermoformed, preferably in a press; that is, said foam is compression molded.

The temperature in step (4) of the process according to the present invention is generally in the range from 160 to 240° C. and preferably in the range from 170 to 210° C. The absolute pressure in the compression mold used in step (4) of the process according to the present invention is generally in the range from 0.001 to 100 bar and preferably in the range from 0.02 to 1 bar.

The thermoforming as per step (4) of the process according to the present invention generally takes place within 15 to 120 seconds.

It is particularly preferable for step (4) of the process according to the present invention to comprise compression molding at a (molding) temperature in the range from 180 to 200° C. and an absolute pressure (molding pressure) in the range from 0.03 to 0.5 bar. Molding time is with particular preference in the range from 30 to 60 seconds.

Contour accuracy in the process according to the present invention is optionally improved by using suitable cooling media to cool down the unopened compression mold after the high-temperature period. Necessary cooling channels may be equidistanced from the mold cavity or, for example in the case of parts having different thicknesses, may preferably be located closer to the cavity in the regions of comparatively large part thicknesses and at comparatively large distances from the cavity in the regions of low part thicknesses. Suitable cooling media are water at mold temperatures <100° C. and oils at temperatures >100° C.

The molding temperatures, pressures and times to be chosen in the individual case usually depend on the composition of the foam, for example the type and quantity of curative, and on the density, thickness and hardness of the foam to be molded including for example after the pretreatment of the foam, which also includes the conditioning in step (3). Other factors to be taken into account include density, thickness, shape and hardness for the desired molding and any coverings or outer layers, see hereinbelow. Molding temperature, pressure and time are preferably adjusted such that the molding obtained in step (4) essentially already has the desired, final three-dimensional shape.

Moldings having a large surface area and/or volume may require a longer molding time than smaller moldings. Moreover, the molding pressure may need to be higher and/or the molding time longer the harder/thicker the conditioned foam is and the higher the desired density for the final molding. Molding temperature and molding pressure can be constant throughout the entire molding time, or may be varied in a suitable manner. Compression molding is generally done under constant conditions, but temperature or pressure programs can also be advantageous in the case of large or complicatedly shaped parts in particular.

The thermoforming, i.e., compression molding, as per step (4) is accomplished in a conventional manner and preferably as a batch operation whereby the conditioned foam obtained in step (3) of the process according to the present invention—preferably as a foam sheet, layer or cut-to-size format—is placed in a suitable press and compression molded. The compression mold is generally temperature-controllable, for example by electric heating or heating via a heat transfer medium, and the press is typically equipped with an ejecting device. So-called contour molds are particularly useful as compression molds since they are particularly capable of producing shaped articles that are to have precisely shaped edges/rims, for example profiled edges or lips.

Useful presses include for example devices known to a person skilled in the art, for example customary daylight presses (single- or multi-daylight presses), toggle presses, down-stroke presses, transfer molding presses, up-stroke presses and also automatic presses. After molding, the press is usually opened and the final molding is removed from the press by an ejecting device. The process described produces foam slabs/sheets, which can be cut into desired shapes.

The shaped articles can be used as such, i.e., with untreated, especially uncovered, surfaces. In a preferred embodiment, one or more surfaces of the shaped article are covered or laminated with outer layers, for example with glass fiber or textile layers, especially with wovens or nonwovens, metal sheets, weaves or foils, polymeric layers, wovens, nonwovens or films/sheets, which may also be in a foamed state. Useful textile layers include fibrous wovens/nonwovens based on glass fibers, polyester fibers, carbon fibers, aramid fibers or flameproofed natural fibers.

The outer layer or covering can be applied to the surface of the shaped article in a conventional manner, for example by bonding with suitable adhesives, or else in the case of wovens and nonwovens in particular by stitching, quilting, tacking, needling or riveting. The outer layer or covering can be applied subsequently to the final molding or—preferably—even as the molding is being produced. For example, in the compression molding of the foam in step (4), the foam can be covered with appropriate outer layers or covering before molding. The outer layers or coverings can also be placed in the compression mold and be molded together with the foam. If, for example, a sheetlike molding is to be covered with a nonwoven A on its bottom side and with a nonwoven B on its top side, the layers can be arranged in the order A-S-B (S=foam layer) before molding, producing the both-sidedly covered molding in one operation.

It will be appreciated that multi-layered laminations are also possible, for example by successively applying further layers to the final molding or, even as the molding is being produced, by molding superposed layers previously arranged in the desired order. It is naturally also possible to apply a first lamination in the course of molding and an additional lamination afterwards. It is particularly preferable for one or more surfaces of the shaped article to be covered with a hydrophobic or oleophobic layer of textile.

As a hydrophobic layer of textile there may be used for example glass fibers, polyester fibers or polyamide fibers that have been rendered hydrophobic with paraffin, silicone or fluoroalkane emulsions. By way of oleophobic layer of textile there may be used for example glass fibers, polyester fibers or polyamide fibers which have been rendered oleophobic with fluoroalkane emulsions.

The melamine-formaldehyde foam obtainable by the process of the present invention preferably has an open-cell structure with an open-cell content, as measured to DIN ISO 4590, of more than 50%, especially more than 80%.

Average pore diameter is preferably in the range from 10 to 1000 μm and especially in the range from 50 to 600 μm.

The foam of the present invention is preferably resilient.

The melamine-formaldehyde foam obtainable by the process of the present invention can be used in various ways for thermal and acoustical insulation in building construction and in automobile, ship and truck vehicle construction, the construction of spacecraft or in the upholstery industry, for example for thermal insulation in house building or as a sound-insulating material, for example in automobiles, airplanes, trains, ships, etc. in passenger cells or in the engine compartment or for cushioning sitting and lying surfaces and also for back and arm rests. Applications are preferably in sectors requiring high thermal stability and low flammability, for example in pore burners.

The present invention therefore also provides for the use of a melamine-formaldehyde foam according to the present invention for acoustical or thermal insulation in building construction, in automobile, ship and track vehicle construction, the construction of spacecraft, in the upholstery industry or for insulating pipework lines.

In particular applications it can be advantageous for the surface of the foams of the present invention to be laminated with a lamination known in principle to a person skilled in the art. Such laminations may be effected for example with substantial retention of the acoustical properties, with so-called “open” systems, for example perforated plates, or else with “closed” systems, for example foils or plates of plastic, metal or wood, especially as mentioned above.

The melamine-formaldehyde foams of the present invention, which contain from 0.01 to 50 wt % of at least one particulate filling material, can be used for thermocompression.

### EXAMPLES

The hereinbelow mentioned ram pressure measurements for assessing the mechanical quality of melamine resin foams were carried out as described in U.S. Pat. No. 4,666,948 A. A cylindrical ram having a diameter of 8 mm and a height of 10 cm was pressed into a cylindrical sample having a diameter of 11 cm and a height of 5 cm in the direction of foaming at an angle of 90° until the sample tore. The tearing force [N], hereinafter also referred to as the ram pressure value, provides information as to the mechanical quality of the foamed material.

### Comparative Example V-A

Preparation of a Melamine-Formaldehyde Foam with a Melamine-Formaldehyde Precondensate (Molar Ratio 1:3.0) without Filling Materials

75 parts by weight of a spray-dried melamine-formaldehyde precondensate (molar ratio 1:3) were dissolved in 25 parts by weight of water, and then 3 wt % of formic acid, 2 wt % of a sodium C₁₂/C₁₄-alkyl sulfate, 20 wt % of pentane, all based on the precondensate, were added; this was followed by stirring and then foaming in a polypropylene mold (for foaming) by irradiation with microwave energy. After foaming, the foam was dried for 30 minutes and then conditioned at 220° C. in a ventilator-generated flow of hot air for 10 min.

The melamine-formaldehyde foam obtained has a density of 7.2 g/l and a ram pressure value of 19.9 N.

### Comparative Example V-B

Preparation of a melamine-formaldehyde foam with 25 wt % of low density polyethylene (LDPE) wax, based on the total weight of particulate filling material plus melamine-formaldehyde precondensate used for foam production, as filling material.

75 parts by weight of a spray-dried melamine-formaldehyde precondensate (molar ratio 1:3) were dissolved in 25 parts by weight of water, then 3 wt % of formic acid, 2 wt % of a sodium C₁₂/C₁₄-alkyl sulfate, 20 wt % of pentane, all based on the precondensate, and 25 parts by weight of LDPE wax, ground from Luwax A granules, particle size: 0.8 to 1.2 mm, average particle diameter 1.0 mm (d₅₀ value, number averaged, determined via optical or electron microscopy combined with image analysis), melting point: 101-109° C. (DIN 51007, DSC), were added, which was followed by stirring and then foaming in a polypropylene mold (for foaming) by irradiation with microwave energy. After foaming, the foam was dried for 30 minutes and then conditioned at 220° C. in a ventilator-generated flow of hot air for 10 min.

The melamine-formaldehyde foam obtained has a density of 10.1 g/l and a ram pressure value of 19.7 N.

### Comparative Example V-C

Preparation of a Melamine-Formaldehyde Foam with a Melamine-Formaldehyde Precondensate (Molar Ratio 1:1.6) without Filling Materials 70 parts by weight of a spray-dried melamine-formaldehyde precondensate (molar ratio 1:1.6) and 5.25 parts by weight of urea are dissolved in water. This resin solution is admixed with 3 wt % of formic acid, 2 wt % of a sodium C₁₂/C₁₄-alkyl sulfate and 10 wt % of pentane, all based on the precondensate. Vigorous stirring is followed by foaming in a polypropylene mold (for foaming) by irradiation with microwave energy. The foam was dried and then conditioned at 110° C. in a ventilator-generated flow of hot air for 10 min.

The melamine-formaldehyde foam obtained has a density of 7.8 g/l and a ram pressure value of 9.2 N.

### Example 1 (Inventive)

Preparation of a melamine-formaldehyde foam with 25 wt % of LDPE wax, based on the total weight of particulate filling material plus melamine-formaldehyde precondensate used for foam production, as filling material.

75 parts by weight of a spray-dried melamine-formaldehyde precondensate (molar ratio 1:3) were dissolved in 25 parts by weight of water, then 3 wt % of formic acid, 2 wt % of a sodium C₁₂/C₁₄-alkyl sulfate, 20 wt % of pentane, all based on the precondensate, and 25 parts by weight of LDPE wax (Luwax A, BASF SE, particle size: 0.3 to 0.7 mm, average particle diameter 0.42 mm (d₅₀ value, number averaged, determined via optical or electron microscopy combined with image analysis), melting point: 101-109° C. (DIN 51007, DSC) were added, which was followed by stirring and then foaming in a polypropylene mold (for foaming) by irradiation with microwave energy. After foaming, the foam was dried for 30 minutes and then conditioned at 220° C. in a ventilator-generated flow of hot air for 10 min.

The melamine-formaldehyde foam obtained has a density of 10.0 g/l and a ram pressure value of 20.1 N.

### Formaldehyde Emissions

The foams of example 1 and comparative examples V-A and V-B have virtually identical formaldehyde emissions in the range of 0.02 to 0.03 ppm as per DIN 55666 ppm. The foam of comparative example V-C has a formaldehyde evolution of 0.08 ppm. The formaldehyde emissions of the foams are thus below the 0.1 ppm limit laid down in section 1 of the German Regulation Banning Certain Chemicals.

### Thermocompression

The conditioned foams of example 1 and comparative examples V-A, V-B and V-C were cut into sheets 21 mm in thickness. A hydrophobic textile web comprising a blend of PET and viscose cellulose fibers was applied to both the top and bottom surfaces of the sheet. There was a coating of adhesive on one side of the textile webs (polymer mixture, phenolic resin, melamine resin). Thereafter, the individual components were molded together in a contour mold for 60 seconds at a molding temperature of 190° C. and a piston pressure of 45 bar (absolute). The individual foam segments were compressed by 25 to 100% in the process. The moldings were subsequently removed from the mold and assessed for contour accuracy and lip strength.

The moldings as per comparative examples V-A and V-B display an incomplete impression of the geometry of the compression mold with interrupted lips, and therefore were unusable. By contrast, the molding as per example 1 displays a distinct improvement in contour accuracy and lip strength. Comparative example V-C displays a very good impression of the geometry of the compression mold with stable, uninterrupted lips.

Comparative example V-A shows that low-formaldehyde moldings are obtainable from high-formaldehyde melamine resins. A conditioning temperature of 240° C. is required for this. However, the molding obtained was reject material, since its edges were imperfect. Comparative example V-B shows that the particle size of the polymeric granules is an important factor in thermocompression. The particle size in this comparative example is not within the range of the present invention. Thermoforming this foam leads to a defective molding. Comparative example V-C permits the production of thermoformable melamine resin foams, but the mechanical properties of the foams, as determined with reference to the ram pressure, are distinctly inferior.

The examples prove that thermoformable melamine-formaldehyde foams having good mechanical properties combined with low formaldehyde emissions are attainable from melamine-formaldehyde precondensate having a molar ratio greater than 2 for formaldehyde:melamine provided at least one particulate filling material is used with a melting temperature no higher than 220° C. and an average particle diameter in the range from 5 μm to 750 μm.

1.-9. (canceled)

10. A thermoformable melamine-formaldehyde foam comprising from 0.1 to 50 wt % of at least one particulate filling material, wherein the wt % are based on the total weight of filling material plus melamine-formaldehyde precondensate used for foam production, wherein the at least one particulate filling material has a melting point no higher than 220° C. and an average particle diameter in the range from 5 μm to 750 μm.

11. The thermoformable melamine-formaldehyde foam according to claim 10, wherein said at least one particulate filling material is an organic oligomer or polymer.

12. The thermoformable melamine-formaldehyde foam according to claim 10, wherein said at least one particulate filling material is an organic polymer selected from the group consisting of polyethylene, polypropylene, polystyrene, polyester, polycarbonate, polyamide, thermoplastic elastomers and mixtures thereof.

13. The thermoformable melamine-formaldehyde foam according to claim 10 wherein the at least one particulate filling material is embedded in the pore structure of the foam and the average particle diameter corresponds to the average pore diameter of the foam structure.

14. The thermoformable melamine-formaldehyde foam according to claim 10, wherein the molar formaldehyde/melamine ratio of the melamine-formaldehyde precondensate is above 2.

15. The thermoformable melamine-formaldehyde foam according to claim 10, wherein the molar formaldehyde/melamine ratio of the melamine-formaldehyde precondensate is in the range from 2.5 to 3.5.

16. The thermoformable melamine-formaldehyde foam according to claim 10, wherein the melamine-formaldehyde foam has a formaldehyde evolution, as measured to DIN 55666, of 0.1 ppm or less.

17. A process for producing the thermoformable melamine-formaldehyde foam according to claim 16, which comprises foaming at least one melamine-formaldehyde precondensate in a solvent with an acid, a dispersant, a blowing agent and at least one particulate filling material at temperatures above the boiling temperature of the blowing agent, dried and then conditioned at a temperature above 200° C.

18. A process for producing shaped articles which comprises thermoforming the foam according to claim 10.

19. A process which comprises utilizing the melamine-formaldehyde foam according to claim 10, wherein the process is for acoustical or thermal insulation in building construction, in automobile, ship and track vehicle construction, the construction of spacecraft, in the upholstery industry or for insulating pipework lines.
